(19) United States
(12) Patent Application Publication
(10) Pub. No.: US 2026/0122371 A1
(43) Pub. Date: Apr. 30, 2026

(54) IMAGE SENSING DEVICE

(71) Applicant: SK hynix Inc., Icheon-si (KR)

(72) Inventor: Seung Min HAN, Icheon-si (KR)

(21) Appl. No.: 19/352,964

(22) Filed: Oct. 8, 2025

(30) Foreign Application Priority Data
Oct. 31, 2024 (KR) 10-2024-0152858

(51) Int. Cl. H04N 25/709; H04N 25/77

(52) U.S. Cl. CPC H04N 25/709; H04N 25/77

(57) ABSTRACT

Disclosed is an image sensing device which includes a photoelectric conversion region; a floating diffusion region; a transfer transistor connected to the photoelectric conversion region and the floating diffusion region and configured to turn on to operate in an on state to transfer photocharges in the photoelectric conversion region to the floating diffusion region; and a boosting transistor connected to the floating diffusion region and configured to receive a negative voltage, after the transfer transistor transitions from an on state to an off state.

### PRIORITY CLAIM AND CROSS-REFERENCE TO RELATED APPLICATION

This application claims the benefit of priority to Korean Patent Application No. 10-2024-0152858, filed in the Korean Intellectual Property Office on Oct. 31, 2024, the entire contents of which are incorporated herein by reference.

### TECHNICAL FIELD

The present disclosure relates to an image sensing device, and more particularly, relate to an image sensing device preventing a voltage transition delay of a floating diffusion region by including a boosting transistor.

### BACKGROUND

An image sensing device is a device for capturing an optical image by using the property of a photosensitive semiconductor material which reacts to a light. With the development of automotive, medical, computer and communication industries, the demand for a high-performance image sensing device is increasing in various fields such as a smartphone, a digital camera, a game machine, an IoT (Internet of Things), a robot, a security camera, and a medical micro camera.

The image sensing device may be mostly classified as a charge coupled device (CCD) image sensing device or a complementary metal oxide semiconductor device (CMOS) image sensing device. The CCD image sensing device provides better image quality than the CMOS image sensing device. However, the size and power consumption of the CCD image sensing device are larger than those of the CMOS image sensing device. In other words, the size and power consumption of the CMOS image sensing device are smaller than those of the CCD image sensing device. In addition, because the CMOS image sensing device is manufactured by using a CMOS manufacturing technology, a light sensing element and a signal processing circuit may be integrated into a single chip. This may mean that it is possible to manufacture a small-sized image sensing device with low costs. For this reason, the CMOS image sensing device is being developed for many applications including a mobile device.

### SUMMARY

The present disclosure has been made to solve the above-mentioned problems occurring in the prior art while advantages achieved by the prior art are maintained intact.

An aspect of the present disclosure provides an image sensing device preventing a voltage transition delay by including a boosting transistor connected to a floating diffusion region.

Some implementations of the disclosed technology provide an image sensing device in which a dark shading phenomenon is alleviated as a boosting transistor is connected to a floating diffusion region and a reset transistor in series or in parallel.

Various technical problems can be solved by the present disclosure without being limited those mentioned in this patent document.

According to an aspect of the present disclosure, an image sensing device may include a photoelectric conversion region, a floating diffusion region, a transfer transistor connected to the photoelectric conversion region and the floating diffusion region and configured to turn on to operate in an on state to transfer photocharges in the photoelectric conversion region to the floating diffusion region, and a boosting transistor connected to the floating diffusion region and configured to receive a negative voltage, after the transfer transistor transitions from an on state to an off state.

According to an embodiment, the image sensing device may further include a reset transistor and configured to be turned on to reset the floating diffusion region.

According to an embodiment, the image sensing device may further include a reset transistor connected in parallel with the boosting transistor and configured to be turned on to reset the floating diffusion region.

According to an embodiment, a voltage of the boosting signal provided to the boosting transistor may transition from a positive voltage to the negative voltage, after a voltage of a transfer signal provided to the transfer transistor transitions from the on state to the off state.

According to an embodiment, a voltage of a boosting signal provided to the boosting transistor may transition from the negative voltage to a lower negative voltage, after a voltage of a transfer signal provided to the transfer transistor transitions from the on state to the off state.

According to an embodiment, the reset transistor may connect the boosting transistor and a pixel voltage terminal configured to provide power to a pixel.

According to an embodiment, the reset transistor connects the floating diffusion region and a pixel voltage terminal configured to provide power to a pixel.

According to an embodiment, a voltage of a boosting signal provided to the boosting transistor may decrease in response to a transition of a voltage of a reset signal provided to the reset transistor from the on state to the off state.

According to an embodiment, the voltage of the boosting signal may transition from a positive voltage to the negative voltage, in response to the transition of the voltage of the reset signal from the on state to the off state.

According to an embodiment, the voltage of the boosting signal may transition from the negative voltage to a positive voltage, before a voltage of a reset signal provided to the reset transistor transitions from an off state to an on state.

According to an embodiment, a voltage of a boosting signal provided to the boosting transistor may transition from the negative voltage to a positive voltage, in response to a transition of a voltage of a reset signal provided to the reset transistor from the off state to the on state.

According to another embodiment of the present disclosure, an image sensing device may include a photoelectric conversion region that converts an incident light into photocharges, a transfer transistor that includes a first end connected to the photoelectric conversion region, a floating diffusion region that is connected to a second end of the transfer transistor and store the photocharges transferred from the photoelectric conversion region, and a boosting transistor that is connected to the floating diffusion region.

According to another embodiment, a voltage of a boosting signal provided to the boosting transistor may decrease to a negative voltage, after a voltage of a transfer signal provided to the transfer transistor transitions from an on state to an off state.

According to another embodiment, the image sensing device may further include a reset transistor including a first end connected to a pixel voltage terminal configured to supply power to a pixel, and a second end of the reset transistor may be in contact with the boosting transistor.

According to another embodiment, the image sensing device may further include a reset transistor including a first end connected to a pixel voltage terminal, and a second end of the reset transistor is in contact with the floating diffusion region.

According to another embodiment, the voltage of the boosting signal may transition from a positive voltage to a negative voltage, after the voltage of the transfer signal transitions from the on state to the off state.

According to another embodiment, the voltage of the boosting signal may transition from a negative voltage to a lower negative voltage, after the voltage of the transfer signal transitions from the on state to the off state.

According to another embodiment, the voltage of the boosting signal may transition from a negative voltage to a positive voltage, before a voltage of a reset signal provided to the reset transistor transitions from an off state to an on state.

According to another embodiment, the voltage of the boosting signal may transition from a negative voltage to a positive voltage, when a voltage of a reset signal provided to the reset transistor transitions from an off state to an on state.

### BRIEF DESCRIPTION OF THE DRAWINGS

FIG. 1 is an example of a block diagram illustrating an image sensing device based on some implementations of the disclosed technology.

FIG. 2 is an example of an equivalent circuit diagram of a unit pixel included in an image sensing device based on some implementations of the disclosed technology.

FIG. 3 illustrates an example of an operation method of a boosting transistor included in an image sensing device as shown in FIG. 2.

FIG. 4 is an example of an equivalent circuit diagram of a unit pixel included in an image sensing device based on some implementations of the disclosed technology.

FIG. 5 illustrates an example of an operation method of a boosting transistor included in an image sensing device as shown in FIG. 4.

FIG. 6 illustrates another example of an operation method of a boosting transistor as shown in FIG. 4.

### DETAILED DESCRIPTION

Below, various embodiments will be described with reference to the accompanying drawings. However, it should be understood that the present disclosure is not intended to a specific embodiment and includes various modifications, equivalents, and/or alternatives of an embodiment. An embodiment of the present disclosure may provide various effects capable of being directly/indirectly recognized through the present disclosure.

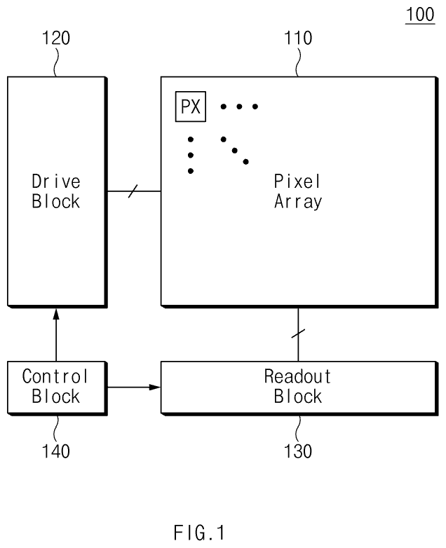

FIG. 1 is a block diagram illustrating an image sensing device according to an embodiment of the present disclosure.

Referring to FIG. 1, an image sensing device 100 may be implemented as a part of an imaging device. The imaging device may mean a device such as a digital still camera which captures a still image or a digital video camera which captures a video. For example, the imaging device may be implemented with a digital single lens reflex (DSLR), a mirrorless camera, or a smartphone, but the present disclosure is not limited thereto.

The image sensing device 100 may be a complementary metal oxide semiconductor image sensor (CIS) which converts a light into an electrical signal. In the present disclosure, the light may include photons causing a photoelectric effect. Also, the light may mean an electromagnetic radiation or electromagnetic wave corresponding to a specific wavelength band belonging to an electromagnetic spectrum.

The image sensing device 100 may include a pixel array 110, a drive block 120, a readout block 130, and a control block 140.

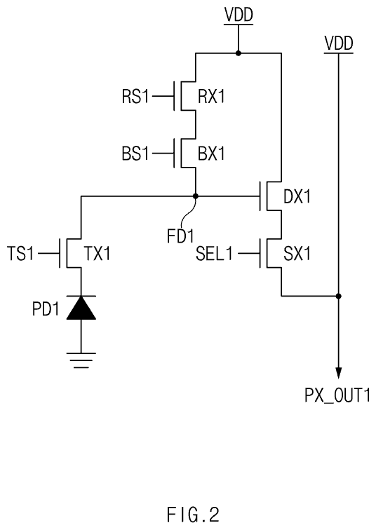

The pixel array 110 may include a plurality of pixels PX arranged continuously in a matrix structure (e.g., arranged continuously in a column direction and/or a row direction). Under control of the drive block 120, each of the plurality of pixels PX may sense an incident light to generate a pixel signal. The pixel signal may be a signal indicating the number of photo charges generated depending on the intensity of the incident light. A structure of each of the pixels PX will be described with reference to FIG. 2.

The pixels PX belonging to one row may be supplied with the same pixel control signal from the drive block 120. The pixels PX belonging to one column may be connected to one column line to output pixel signals to the readout block 130.

The drive block 120 may drive the pixels PX of the pixel array 110 in response to a timing signal output from the control block 140. For example, the drive block 120 may generate a control signal capable of selecting and controlling the pixels PX included in at least one row line among a plurality of row lines of the pixel array 110.

The control signal may include, for example, a row selection signal, a pixel reset signal, a transfer signal, etc., and the corresponding unit pixel of the pixel array 110 may be activated by the control signal to perform an operation corresponding to the row selection signal, the pixel reset signal, and the transfer signal.

Based on the control of the control block 140, the readout block 130 may sense the pixel signal output from the pixel array 110 and may output the sensed pixel signal as image data. The image data may be digital data obtained by performing analog-to-digital conversion on the pixel signal of an analog form. In some implementations, the readout block 130 may include a correlated double sampler (CDS) for performing correlated double sampling on pixel signals output from the pixel array 110. Also, the readout block 130 may include an analog-to-digital converter which converts signals output from the correlated double sampler into digital signals such that pixel data are generated. In addition, the readout block 130 may include a buffer circuit for temporarily storing the pixel data output from the analog-to-digital converter and outputting the temporarily stored pixel data to the outside under control of the control block 140.

The image sensing device 100 may remove an unwanted offset value such as a fixed pattern noise by sampling a pixel signal two times to remove a difference between two samples. According to the correlated double sampling, a pixel output voltage based on only an incident light may be measured by comparing pixel output voltages, which are obtained before and after photo charges generated by the incident light are accumulated in the floating diffusion region, such that the unwanted offset value is removed.

In some implementations, the pixel reset signal and the transfer signal which are associated with a pixel included in the pixel array 110 may be sequentially enabled. A reference pixel signal in the form of an analog signal and an image pixel signal in the form of an analog signal, which are generated from each of the selected pixel, may be output to the correlated double sampler (CDS).

The reference pixel signal may be an electrical signal which is provided to the correlated double sampler of the readout block 130 when the floating diffusion region of the unit pixel is reset. Thus, the reference pixel signal may be a signal corresponding to a voltage of the floating diffusion region when all the photo charges in the floating diffusion region are removed.

The image pixel signal may be an electrical signal which is provided to the correlated double sampler of the readout block 130 when the photo charges generated by the unit pixel are accumulated in the floating diffusion region. In other words, the image pixel signal may be a signal corresponding to a voltage of the floating diffusion region when all the photo charges corresponding to the incident light are transferred to the floating diffusion region.

When all the charges accumulated in the floating diffusion region are removed before the reference pixel signal is detected or when all the photo charges corresponding to the incident light are not transferred to the floating diffusion region before the reference pixel signal is detected, the image pixel signal may be distorted as if it corresponds to photo charges, the amount of which is less than that of the photo charges generated by the unit pixel.

When the voltage of the floating diffusion region fluctuates while the reference pixel signal or the image pixel signal is detected, the pixel signal may experience distortion.

When a gate insulating layer of a transistor which the unit pixel includes is damaged, the coupling between the floating diffusion region and the transistor may be caused; in this case, the image pixel signal may be distorted due to the coupling phenomenon.

The control block 140 may generate the timing signal for controlling operations of the drive block 120 and the readout block 130. According to an embodiment, the control block 140 may generate the timing signal depending on a request of an external processor (e.g., an image signal processor (ISP)). According to an embodiment, the control block 140 may include a logic control circuit, a phase locked loop (PLL) circuit, a timing control circuit, a communication interface circuit, etc.

FIG. 2 is an equivalent circuit diagram of a unit pixel which an image sensing device according to an embodiment of the present disclosure includes.

A unit pixel may be included in the pixel array 110 described with reference to FIG. 1, and a plurality of unit pixels may be repeatedly disposed in the row direction and the column direction of the pixel array 110 of FIG. 1.

The unit pixel may include a photoelectric conversion region PD1 which converts incident light into corresponding photo charges, a transfer transistor TX1, the floating diffusion region, a drive transistor DX1, a select transistor SX1, a boosting transistor (BX1), and a reset transistor (RX1). In the example, the transfer transistor TX1 may be placed between the photoelectric conversion region PD1 and a floating diffusion region FD1 and has opposite ends of a source/drain region connected to the photoelectric conversion region PD1 and the floating diffusion region FD1. The floating diffusion region FD1 may receive the photo charges corresponding to the incident light from the photoelectric conversion region PD1. The drive transistor DX1 may have a gate in contact with the floating diffusion region FD1 and amplify a signal corresponding to a voltage of the floating diffusion region FD1. The select transistor SX1 may be in contact with one end of a source/drain region of the drive transistor DX1 and selectively output the signal generated by the drive transistor DX1. The boosting transistor BX1 may be placed between the floating diffusion region FD1 and a reset transistor RX1 and have one end of a source/drain region in contact with the floating diffusion region FD1. The reset transistor RX1 may be in contact with an opposite end of the source/drain region of the boosting transistor BX1 and reset the unit pixel with a pixel voltage VDD during a reset operation.

The photoelectric conversion region PD1 may be provided in the form of a photodiode, a photo transistor, a photo gate, a pinned photo diode, or any combination thereof.

The transfer transistor TX1 may change to an on state or an off state depending on a voltage of a transfer signal TS1 provided to a transfer transistor gate. According to an embodiment, when the transfer signal TS1 of an on-state voltage is provided to the transfer transistor gate, photo charges generated in the photoelectric conversion region PD1 may move to the floating diffusion region FD1.

When the voltage of the transfer signal TS1 provided to the transfer transistor gate of the transfer transistor TX1 transitions from the on state to the off state, the photoelectric conversion region PD1 and the floating diffusion region FD1 may be electrically separated. The on state refers to a level of the voltage that causes a corresponding transistor to turn on and the off-state refers to a level of the voltage that causes the corresponding transistor to turn off.

The floating diffusion region FD1 may refer to a region which stores the photo charges generated in the photoelectric conversion region PD1. The floating diffusion region FD1 may be a region connected to a gate of the drive transistor DX1, and a voltage change of the floating diffusion region FD1 may be amplified by the drive transistor DX1 so as to be transferred to the select transistor SX1 connected to the drive transistor DX1.

The drive transistor DX1 may serve as a source follower. The amplified voltage may be output as a pixel signal PX_OUT1 depending on whether a selection signal SEL1 is applied to a gate of the select transistor SX1.

The boosting transistor BX1 and the reset transistor RX1 may be connected in series, and one end of the source/drain region of the boosting transistor BX1 may be connected to the floating diffusion region FD1.

The on-state voltage may be provided to a gate of the boosting transistor BX1 and a gate of the reset transistor RX1 at the timing when the unit pixel is reset with the pixel voltage VDD.

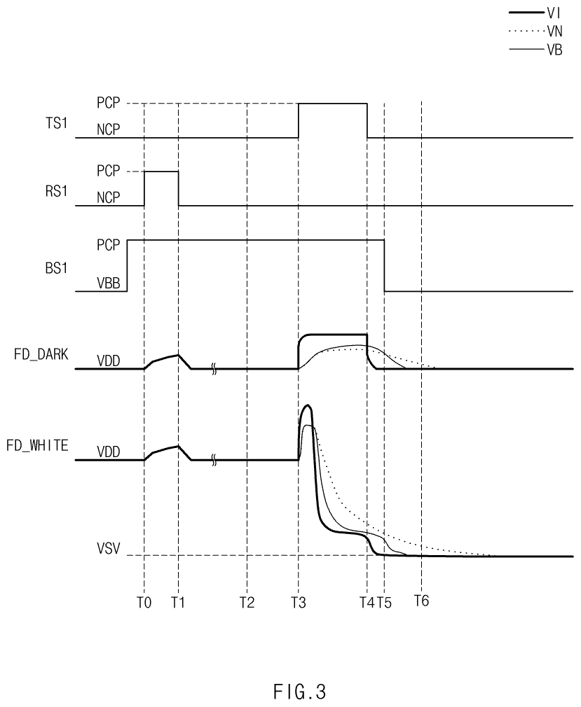

According to an embodiment of the present disclosure, a boosting signal BS1 which is provided to the gate of the boosting transistor BX1 may transition from a high voltage to a low voltage after the voltage of the transfer signal TS1 provided to the gate of the transfer transistor TX1 transitions from the on state to the off state. In this case, the high voltage may be a positive voltage, and the low voltage may be a negative voltage. An operation method of the boosting transistor BX1 will be described in detail with reference to FIG. 3.

One end of a source/drain region of the reset transistor RX1 may be connected to a pixel voltage (VDD) terminal. The pixel voltage terminal is configured to provide a pixel voltage (VDD) to a pixel to power the pixel. When the on-state voltage is provided to the gate of the reset transistor RX1, the entire unit pixel may be reset with a pixel voltage (VDD) level.

In the image sensing device 100 according to an embodiment of the present disclosure, the photo charges generated in the photoelectric conversion region PD1 may be transferred to the floating diffusion region FD1 by the transfer transistor TX1, and a voltage level of the floating diffusion region FD1 may be amplified by the drive transistor DX1 so as to be detected as the pixel signal PX_OUT1.

According to an embodiment, the image sensing device 100 may amplify a voltage of the floating diffusion region FD1 that has received the photo charges and a voltage of the floating diffusion region FD1 from which the photo charges are removed, through the drive transistor DX1. The image sensing device 100 may generate the pixel signal PX_OUT1 corresponding to the incident light by comparing signals corresponding to the two amplified voltages through the correlated double sampler.

An insulating layer included in an image sensing device may be damaged during the manufacturing process of the image sensing device. The interface of the damaged insulating film may have its physical property changed. In an embodiment, as a hydrophobic insulating layer becomes hydrophilic due to the damage, the dielectric constant of the insulating layer may increase.

When the dielectric constant of the insulating layer increases, a parasitic capacitance value of the floating diffusion region FD1 may increase. When the parasitic capacitance value of the floating diffusion region FD1 increases, the noise may occur in the voltage of the floating diffusion region FD1, that the image sensing device reads out.

The voltage of the floating diffusion region FD1 may fluctuate depending on whether a transistor (e.g., the transfer transistor TX1 or the reset transistor RX1) connected to the floating diffusion region FD1 is turned on or turned off. As the transistor connected to the floating diffusion region FD1 and the voltage of the floating diffusion region FD1 are coupled, the voltage of the floating diffusion region FD1 may fluctuate.

When a voltage is provided to a gate of the transistor connected to the floating diffusion region FD1, the voltage of the floating diffusion region FD1 may fluctuate. If the time it takes for the voltage fluctuation of the floating diffusion region FD1 to stabilize becomes long, the voltage fluctuations caused by the voltage provided to the gate of the transistor may be abnormally and incorrectly sensed as the voltage of the floating diffusion region FD1, thereby causing noise in the pixel signal.

When the dielectric constant of the insulating layer increases, the voltage coupling between the floating diffusion region FD1 and the transistor may become stronger, and the voltage fluctuations in the floating diffusion region FD1 due to the turn-on/off of the transistor may continue during a relatively long time. This may cause an increase in the noise occurrence frequency and an increase in the value of the generated noise, in association with the pixel signal.

When an active voltage is provided to the gate of the transistor connected to the floating diffusion region FD1, the voltage of the floating diffusion region FD1 coupled to the transistor may be higher than the voltage of the stabilized state.

When the voltage of the floating diffusion region FD1 is sensed before the voltage of the floating diffusion region FD1 is stabilized, the amount of photo charges transferred to the floating diffusion region FD1 may be distorted; in this case, a reset state voltage of the floating diffusion region FD1 may be sensed as being higher than an actual voltage.

Alternatively, when the photo charges corresponding to the incident light are transferred to the floating diffusion region FD1 by the transfer transistor TX1, the transfer of the photo charges to the floating diffusion region FD1 may be delayed due to coupling between the transfer transistor TX1 and the floating diffusion region FD1.

When the transfer of the photo charges to the floating diffusion region FD1 is delayed, the voltage of the floating diffusion region FD1 may be measured as being higher than an actual voltage. Thus, the amount of photo charges transferred to the floating diffusion region FD1 may be distorted to be smaller than the amount of photo charges actually provided to the floating diffusion region FD1.

Accordingly, a signal corresponding to the light, the amount of which is smaller than the amount of light actually incident onto the image sensing device, may be output as the pixel signal PX_OUT1.

The phenomenon that a pixel signal to be output becomes smaller due to the coupling phenomenon of the floating diffusion region FD1 may be referred to as “dark shading”.

To prevent the dark shading, the boosting transistor BX1 connected to the floating diffusion region FD1 may be provided, and the voltage of a boosting signal BS1 provided to the gate of the boosting transistor BX1 can be controlled to quickly decrease the voltage of the floating diffusion region FD1.

One end of the boosting transistor BX1 according to an embodiment of the present disclosure may be connected to the floating diffusion region FD1.

After a voltage of a transfer signal which is provided to a gate of a transfer transistor transitions from the on state to the off state, a boosting signal which is provided to a gate of a boosting transistor may transition from a first voltage to a second voltage lower than the first voltage. In this case, the second voltage may be a negative voltage.

When the negative voltage is provided to the gate of the boosting transistor connected to the floating diffusion region FD1, the voltage fluctuations of the floating diffusion region FD1 may be more quickly stabilized. As the voltage fluctuations of the floating diffusion region FD1 is more quickly stabilized, the noise may not occur when the voltage of the floating diffusion region FD1 is sensed, and thus, a higher-quality image signal may be obtained.

FIG. 3 illustrates an example of an operation method of the boosting transistor BX1 included in an image sensing device as shown in FIG. 2.

An operation method of the boosting transistor BX1 which an image sensing device includes will be described in detail with reference to FIGS. 2 and 3.

A voltage of a floating diffusion region according to an operation of a unit pixel may be illustrated in FIG. 3. In particular, a floating diffusion region voltage FD_DARK of a dark state in which the incident light is not received and a floating diffusion region voltage FD_WHITE of a white state (hereinafter referred to as a “light receiving state”) in which the incident light is received are illustrated together for comparison.

Also, a floating diffusion region voltage curve VI of an ideal image sensing device, a floating diffusion region voltage curve VN of an image sensing device not including the boosting transistor, and a floating diffusion region voltage curve VB of an image sensing device including the boosting transistor are illustrated together.

A time period from T0 to T1 of FIG. 3 may correspond to the timing when the unit pixel is reset.

The boosting signal BS1 which is provided to the gate of the boosting transistor BX1 before the reset period from T0 to T1 may have an on-state voltage PCP. The on-state voltage PCP may be a positive voltage.

During the reset period from T0 to T1, the transfer signal TS1 which is provided to the gate of the transfer transistor TX1, the boosting signal BS1 which is provided to the gate of the boosting transistor BX1, and a reset signal RS1 which is provided to the gate of the reset transistor RX1 may have the on-state voltage PCP.

During the reset period from T0 to T1, elements (e.g., a floating diffusion region FD, a photoelectric conversion region PD, etc.) which the unit pixel includes may be reset with the pixel voltage VDD.

As the transfer signal TS1 provided to the gate of the transfer transistor TX1 and the boosting signal BS1 provided to the gate of the boosting transistor BX1 have the on-state voltage PCP during the reset period from T0 to T1, the floating diffusion region voltage FD_DARK of the dark state may increase during the reset period from T0 to T1. Likewise, the floating diffusion region voltage FD_WHITE of the light receiving state may also increase during 5 the reset period from T0 to T1.

After timing T1, a reference pixel signal of the unit pixel may be sensed at timing T2.

When the unit pixel is in the light receiving state, a time period from T1 to T3 may be a time period in which the incident light is converted into corresponding photo charges in the photoelectric conversion region PD.

A pixel signal of the dark state output at timing T2 may be identical to a pixel signal of the light receiving state output at timing T2. In other words, at timing T2, the floating diffusion region voltage FD_DARK of the dark state may be identical to the floating diffusion region voltage FD_WHITE of the light receiving state.

The pixel signal output at timing T2 may be referred to as a “reference pixel signal”. The reference pixel signal may be a signal corresponding to a voltage which the floating diffusion region FD has in a state where the unit pixel is reset with the pixel voltage VDD.

Below, after a change in the floating diffusion region voltage FD_DARK of the dark state is described, a change in the floating diffusion region voltage FD_WHITE of the light receiving state will be described.

When the transfer signal TS1 provided to the gate of the transfer transistor TX1 has the on-state voltage PCP (during a time period from T3 to T4), the floating diffusion region voltage FD_DARK of the dark state may increase.

In the case of the ideal image sensing device, the floating diffusion region voltage FD_DARK of the dark state may change like the floating diffusion region voltage curve VI. According to the floating diffusion region voltage curve VI, at timing T4 when the transfer signal TS1 provided to the gate of the transfer transistor TX1 transitions from the on-state voltage PCP to an off-state voltage NCP, the floating diffusion region voltage FD_DARK of the dark state may decrease to the pixel voltage VDD.

After the floating diffusion region voltage FD_DARK of the dark state decreases to the pixel voltage VDD, an image pixel signal may be output at timing T6. In the case of the dark state, because the photo charges corresponding to the incident light are not generated, at timing T6, the floating diffusion region voltage FD_DARK of the dark state may be the pixel voltage VDD.

In contrast, when the transfer transistor TX1 and the floating diffusion region FD1 are coupled due to the degradation of the insulating layer, the floating diffusion region voltage FD_DARK of the dark state may change like the floating diffusion region voltage curve VN. According to the floating diffusion region voltage curve VN, after the transfer signal TS1 provided to the gate of the transfer transistor TX1 transitions from the on-state voltage PCP to the off-state voltage NCP, even though timing T6 to output the image pixel signal arrives, the floating diffusion region voltage FD_DARK of the dark state may be higher than the pixel voltage VDD.

When the floating diffusion region voltage FD_DARK of the dark state is output in a state of being higher than the pixel voltage VDD, the noise may occur at the image pixel signal.

In the case of the unit pixel including the boosting transistor BX1, the floating diffusion region voltage FD_DARK of the dark state may change like the floating diffusion region voltage curve VB. According to the floating diffusion region voltage curve VB, after the transfer signal TS1 provided to the gate of the transfer transistor TX1 transitions from the on-state voltage PCP to the off-state voltage NCP (at timing T4), at timing T5, the boosting signal BS1 provided to the gate of the boosting transistor BX1 may transition from the on-state voltage PCP to a low voltage VBB. According to an embodiment, the low voltage VBB may be a negative voltage.

As the negative voltage is applied to the gate of the boosting transistor BX1 connected to the floating diffusion region FD1, in the time period from T4 to T5, the floating diffusion region voltage FD_DARK of the dark state may quickly decrease like the floating diffusion region voltage curve VB. Afterwards, when timing T6 to output the image pixel signal arrives, the floating diffusion region voltage FD_DARK of the dark state may be the pixel voltage VDD.

As described above, in the case of the dark state, as the voltage of the floating diffusion region FD1 quickly transitions to the pixel voltage VDD by the boosting transistor BX1, the reference pixel signal of the dark state output at timing T2 and the image pixel signal of the dark state output at timing T6 may have the same value.

Below, the change in the floating diffusion region voltage FD_WHITE of the light receiving state will be described with reference to drawings.

When the transfer signal TS1 provided to the gate of the transfer transistor TX1 has the on-state voltage PCP (during the time period from T3 to T4), the floating diffusion region voltage FD_WHITE of the light receiving state may temporarily increase and may then decrease.

In the case of the ideal image sensing device, the floating diffusion region voltage FD_WHITE of the light receiving state may change like the floating diffusion region voltage curve VI. According to the floating diffusion region voltage curve VI, the voltage FD_WHITE of the floating diffusion region FD1 may instantaneously increase at timing T3 when the transfer signal TS1 provided to the gate of the transfer transistor TX1 transitions to the on-state voltage PCP and may then decrease until timing T4 when the transfer signal TS1 transitions to the off-state voltage NCP. The reason is that the voltage of the floating diffusion region FD1 decreases to a negative voltage as the photo charges corresponding to the incident light are transferred from the photoelectric conversion region PD1 to the floating diffusion region FD1.

When the photo charges generated in the photoelectric conversion region PD1 are accumulated in the floating diffusion region FD1, the floating diffusion region voltage FD_WHITE of the light receiving state may decrease to an accumulation voltage VSV. At timing T6, the image sensing device may output the image pixel signal. In the case of the light receiving state, at timing T6, the ideal floating diffusion region voltage FD_WHITE may be the accumulation voltage VSV.

In contrast, when the transfer transistor TX1 and the floating diffusion region FD1 are coupled due to the degradation of the insulating layer, the floating diffusion region voltage FD_WHITE of the light receiving state may change like the floating diffusion region voltage curve VN. According to the floating diffusion region voltage curve VN, after the transfer signal TS1 provided to the gate of the transfer transistor TX1 transitions from the on-state voltage PCP to the off-state voltage NCP, even though timing T6 to output the image pixel signal arrives, the floating diffusion region voltage FD_WHITE of the light receiving state may be higher than the accumulation voltage VSV.

When the floating diffusion region voltage FD_WHITE of the light receiving state is output in a state of being higher than the accumulation voltage VSV, the noise may occur at the image pixel signal. In detail, when a signal corresponding to a voltage higher than the accumulation voltage VSV is output as the image pixel signal, a signal corresponding to photo charges, the amount of which is smaller than the amount of photo charges generated in the photoelectric conversion region PD1, may be output as the image pixel signal; in this case, the captured image may be distorted as if it is darker than an actual image.

In the case of the unit pixel including the boosting transistor BX1, the floating diffusion region voltage FD_WHITE of the light receiving state may change like the floating diffusion region voltage curve VB. According to the floating diffusion region voltage curve VB, after the transfer signal TS1 provided to the gate of the transfer transistor TX1 transitions from the on-state voltage PCP to the off-state voltage NCP (at timing T4), at timing T5, the boosting signal BS1 provided to the gate of the boosting transistor BX1 may transition from the on-state voltage PCP to the low voltage VBB. According to an embodiment, the low voltage VBB may be a negative voltage.

As the negative voltage is applied to the gate of the boosting transistor BX1 connected to the floating diffusion region FD1, in the time period from T4 to T5, the floating diffusion region voltage FD_WHITE of the light receiving state may quickly decrease like the floating diffusion region voltage curve VB. Afterwards, when timing T6 to output the image pixel signal arrives, the floating diffusion region voltage FD_WHITE of the light receiving state may be the accumulation voltage VSV.

In the case of the light receiving state, as the voltage of the floating diffusion region FD1 quickly transitions to the pixel voltage VDD by the boosting transistor BX1, the image pixel signal of the light receiving state output at timing T6 may be output as a value corresponding to all the photo charges generated in the photoelectric conversion region PD1.

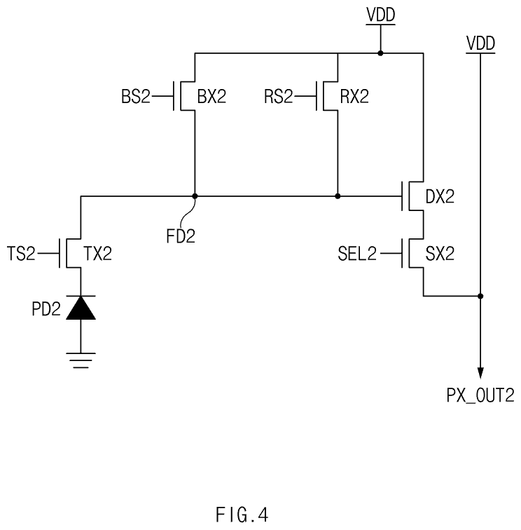

FIG. 4 is an equivalent circuit diagram of a unit pixel which an image sensing device according to another embodiment of the present disclosure includes.

As described above, a unit pixel may be repeatedly disposed in the row direction and the column direction on the pixel array 110 (refer to FIG. 1).

The unit pixel of FIG. 4 may include a photoelectric conversion region PD2, a transfer transistor TX2 which is placed between the photoelectric conversion region PD2 and a floating diffusion region FD2 and includes opposite ends of a source/drain region connected to the photoelectric conversion region PD2 and the floating diffusion region FD2, the floating diffusion region FD2 which receives photo charges from the photoelectric conversion region PD2, a drive transistor DX2 which includes a gate connected to the floating diffusion region FD2, a select transistor SX2 which is in contact with one end of a source/drain region of the drive transistor DX2 and outputs a signal generated by the drive transistor DX2 as a pixel signal PX_OUT2 depending on a level of a selection signal SEL2.

Also, the unit pixel may include a boosting transistor BX2 connected in parallel with a reset transistor RX2. One end of a source/drain region of the boosting transistor BX2 may be in contact with the floating diffusion region FD2, and an opposite end thereof may be in contact with the pixel voltage (VDD) terminal.

Also, one end of a source/drain region of the reset transistor RX2 which the unit pixel includes may be in contact with the floating diffusion region FD2, and an opposite end thereof may be in contact with the pixel voltage (VDD) terminal.

A transfer signal TS2 which is provided to a gate of the transfer transistor TX2, a reset signal RS2 which is provided to a gate of the reset transistor RX2, and a boosting signal BS2 which is provided to a gate of the boosting transistor BX2 are illustrated in FIG. 4.

The remaining components except for the placement of the boosting transistor BX2 are substantially the same as those of the circuit diagram described with reference to FIG. 2, and thus, additional description will be omitted to avoid redundancy.

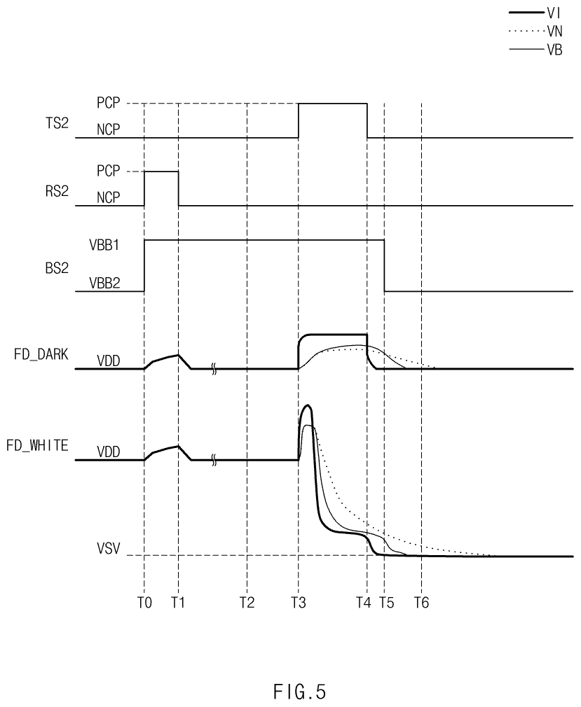

FIG. 5 illustrates an example of an operation method of the boosting transistor BX2 included in an image sensing device according to the embodiment of FIG. 4.

A voltage of a floating diffusion region according to an operation of a unit pixel may be illustrated in FIG. 5. In some implementations, a floating diffusion region voltage FD_DARK of a dark state in which the incident light is not received and a floating diffusion region voltage FD_WHITE of a white state (hereinafter referred to as a “light receiving state”) in which the incident light is received are illustrated together for comparison.

In some implementations, a floating diffusion region voltage curve VI of an ideal image sensing device, a floating diffusion region voltage curve VN of an image sensing device not including the boosting transistor, and a floating diffusion region voltage curve VB of an image sensing device including the boosting transistor are illustrated together.

A time period from T0 to T1 of FIG. 5 may correspond to the timing when the unit pixel is reset.

At timing T0 when the reset period from T0 to T1 starts, the boosting signal BS2 which is provided to the gate of the boosting transistor BX2 may increase from a second voltage VBB2 to a first voltage VBB1. The first voltage VBB1 and the second voltage VBB2 may be negative voltages.

During the reset period from T0 to T1, the transfer signal TS2 which is provided to the gate of the transfer transistor TX2 may have the on-state voltage PCP.

Unlike the embodiment of FIG. 3, the boosting signal BS2 which is provided to the gate of the boosting transistor BX2 during the reset period from T0 to T1 may have the first voltage VBB1.

During the reset period from T0 to T1, elements (e.g., the floating diffusion region FD2, the photoelectric conversion region PD2, etc.) which the unit pixel includes may be reset with the pixel voltage VDD.

As the transfer signal TS2 provided to the gate of the transfer transistor TX2 have the on-state voltage PCP during the reset period from T0 to T1, the floating diffusion region voltage FD_DARK of the dark state may increase during the reset period from T0 to T1. Likewise, the floating diffusion region voltage FD_WHITE of the light receiving state may also increase during the reset period from T0 to T1.

After timing T1, a reference pixel signal of the unit pixel may be sensed at timing T2.

When the unit pixel is in the light receiving state, a time period from T1 to T3 may be a time period in which the incident light is converted into corresponding photo charges in the photoelectric conversion region PD2.

At timing T2, the floating diffusion region voltage FD_DARK of the dark state may be identical to the floating diffusion region voltage FD_WHITE of the light receiving state.

The pixel signal output at timing T2 may be referred to as a “reference pixel signal”. The reference pixel signal may be a signal corresponding to a voltage which the floating diffusion region FD2 has in a state where the unit pixel is reset with the pixel voltage VDD.

Below, after a change in the floating diffusion region voltage FD_DARK of the dark state is described, a change in the floating diffusion region voltage FD_WHITE of the light receiving state will be described.

When the transfer signal TS2 provided to the gate of the transfer transistor TX2 has the on-state voltage PCP (during a time period from T3 to T4), the floating diffusion region voltage FD_DARK of the dark state may increase.

In the case of the ideal image sensing device, the floating diffusion region voltage FD_DARK of the dark state may change like the floating diffusion region voltage curve VI. According to the floating diffusion region voltage curve VI, at timing T4 when the transfer signal TS2 provided to the gate of the transfer transistor TX2 transitions from the on-state voltage PCP to the off-state voltage NCP, the floating diffusion region voltage FD_DARK of the dark state may decrease to the pixel voltage VDD.

After the floating diffusion region voltage FD_DARK of the dark state decreases to the pixel voltage VDD, an image pixel signal may be output at timing T6. In the case of the dark state, because the photo charges corresponding to the incident light are not generated, at timing T6, the floating diffusion region voltage FD_DARK of the dark state may be the pixel voltage VDD.

In contrast, when the transfer transistor TX2 and the floating diffusion region FD2 are coupled due to the degradation of the insulating layer, the floating diffusion region voltage FD_DARK of the dark state may change like the floating diffusion region voltage curve VN. According to the floating diffusion region voltage curve VN, after the transfer signal TS2 provided to the gate of the transfer transistor TX2 transitions from the on-state voltage PCP to the off-state voltage NCP, even though timing T6 to output the image pixel signal arrives, the floating diffusion region voltage FD_DARK of the dark state may be higher than the pixel voltage VDD.

When the floating diffusion region voltage FD_DARK of the dark state is output in a state of being higher than the pixel voltage VDD, the noise may occur at the image pixel signal.

In the case of the unit pixel including the boosting transistor BX2, the floating diffusion region voltage FD_DARK of the dark state may change like the floating diffusion region voltage curve VB. According to the floating diffusion region voltage curve VB, after the transfer signal TS2 provided to the gate of the transfer transistor TX2 transitions from the on-state voltage PCP to the off-state voltage NCP (at timing T4), at timing T5, the boosting signal BS2 provided to the gate of the boosting transistor BX2 may transition from the first voltage VBB1 to the second voltage VBB2. According to an embodiment, both the first voltage VBB1 and the second voltage VBB2 may be negative voltages, and the second voltage VBB2 may be lower than the first voltage VBB1.

As the negative voltage is applied to the gate of the boosting transistor BX2 connected to the floating diffusion region FD2, in the time period from T5 to T6, the floating diffusion region voltage FD_DARK of the dark state may quickly decrease like the floating diffusion region voltage curve VB. Afterwards, when timing T6 to output the image pixel signal arrives, the floating diffusion region voltage FD_DARK of the dark state may be the pixel voltage VDD.

Below, the change in the floating diffusion region voltage FD_WHITE of the light receiving state will be described with reference to drawings.

When the transfer signal TS2 provided to the gate of the transfer transistor TX2 has the on-state voltage PCP (during the time period from T3 to T4), the floating diffusion region voltage FD_WHITE of the light receiving state may temporarily increase and may then decrease.

In the case of the ideal image sensing device, the floating diffusion region voltage FD_WHITE of the light receiving state may change like the floating diffusion region voltage curve VI. According to the floating diffusion region voltage curve VI, the voltage FD_WHITE of the floating diffusion region FD2 may instantaneously increase at timing T3 when the transfer signal TS2 provided to the gate of the transfer transistor TX2 transitions to the on-state voltage PCP and may then decrease until timing T4 when the transfer signal TS2 transitions to the off-state voltage NCP. The reason is that the voltage of the floating diffusion region FD2 decreases to a negative voltage as the photo charges corresponding to the incident light are transferred from the photoelectric conversion region PD2 to the floating diffusion region FD2.

When the photo charges generated in the photoelectric conversion region PD2 are accumulated in the floating diffusion region FD2, the floating diffusion region voltage FD_WHITE of the light receiving state may decrease to the accumulation voltage VSV. At timing T6, the image sensing device may output the image pixel signal. In the case of the light receiving state, at timing T6, the ideal floating diffusion region voltage FD_WHITE may be the accumulation voltage VSV.

In contrast, when the transfer transistor TX2 and the floating diffusion region FD2 are coupled due to the degradation of the insulating layer, the floating diffusion region voltage FD_WHITE of the light receiving state may change like the floating diffusion region voltage curve VN. According to the floating diffusion region voltage curve VN, after the transfer signal TS2 provided to the gate of the transfer transistor TX2 transitions from the on-state voltage PCP to the off-state voltage NCP, even though timing T6 to output the image pixel signal arrives, the floating diffusion region voltage FD_WHITE of the light receiving state may be higher than the accumulation voltage VSV.

When the floating diffusion region voltage FD_WHITE of the light receiving state is output in a state of being higher than the accumulation voltage VSV, the noise may occur at the image pixel signal. In detail, when a signal corresponding to a voltage higher than the accumulation voltage VSV is output as the image pixel signal, a signal corresponding to photo charges, the amount of which is smaller than the amount of photo charges generated in the photoelectric conversion region PD2, may be output as the image pixel signal; in this case, the captured image may be distorted as if it is darker than an actual image.

In the case of the unit pixel including the boosting transistor BX2, the floating diffusion region voltage FD_WHITE of the light receiving state may change like the floating diffusion region voltage curve VB. According to the floating diffusion region voltage curve VB, after the transfer signal TS2 provided to the gate of the transfer transistor TX2 transitions from the on-state voltage PCP to the off-state voltage NCP (at timing T4), at timing T5, the boosting signal BS2 provided to the gate of the boosting transistor BX2 may transition from the first voltage VBB1 to the second voltage VBB2 being lower than the first voltage VBB1.

As the negative voltage is applied to the gate of the boosting transistor BX2 connected to the floating diffusion region FD2, in the time period from T5 to T6, the floating diffusion region voltage FD_WHITE of the light receiving state may quickly decrease like the floating diffusion region voltage curve VB. Afterwards, when timing T6 to output the image pixel signal arrives, the floating diffusion region voltage FD_WHITE of the light receiving state may be the accumulation voltage VSV.

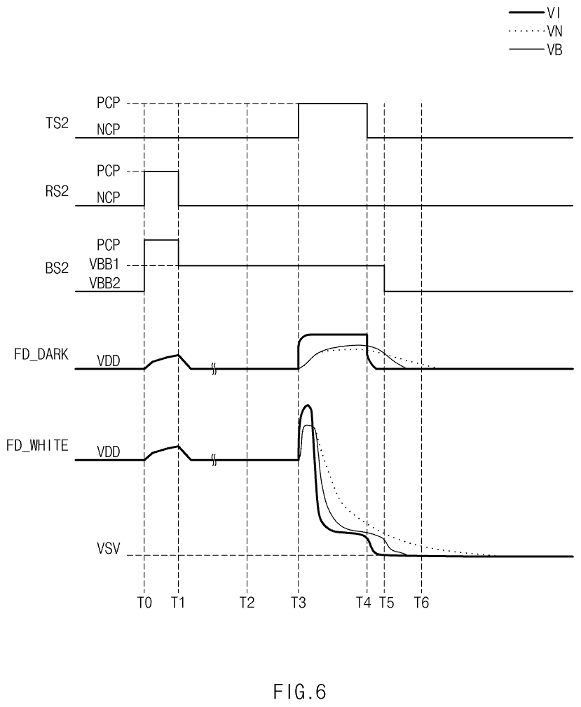

FIG. 6 is for describing another operation method of the boosting transistor BX2 which an image sensing device according to the embodiment of FIG. 4 includes.

In FIG. 6, only the voltage of the boosting signal BS2 provided to the gate of the boosting transistor BX2 in the time period from T0 to T1 may be different from that of the operation method of FIG. 5, and thus, the time period from T0 to T1 will be mainly described.

A time period from T0 to T1 of FIG. 6 may correspond to the timing when the unit pixel is reset.

The boosting signal BS2 which is provided to the gate of the boosting transistor BX2 before the reset period from T0 to T1 may have the on-state voltage PCP. The on-state voltage PCP may be a positive voltage.

During the reset period from T0 to T1, the transfer signal TS2 which is provided to the gate of the transfer transistor TX2 may have the on-state voltage PCP.

Unlike the embodiment of FIG. 5, the boosting signal BS2 which is provided to the gate of the boosting transistor BX2 during the reset period from T0 to T1 may have the on-state voltage PCP, and thus, the boosting transistor BX2 may be in the on state.

During the reset period from T0 to T1, as the boosting transistor BX2 is set to the on state, the photoelectric conversion region PD2 and the floating diffusion region FD2 may be more quickly reset with the pixel voltage VDD.

When the voltage of the reset signal RS2 provided to the reset transistor RX2 transitions from the on-state voltage PCP to the off-state voltage NCP, the boosting signal BS2 provided to the gate of the boosting transistor BX2 may transition from the on-state voltage PCP to the first voltage VBB1. As the voltage of the boosting signal BS2 transitions from the on-state voltage PCP to the first voltage VBB1, the boosting transistor BX2 may be set to the off state.

After timing T1, a reference pixel signal of the unit pixel may be sensed at timing T2. The pixel signal output at timing T2 may be referred to as a “reference pixel signal”.

When the unit pixel is in the light receiving state, a time period from T1 to T3 may be a time period in which the incident light is converted into corresponding photo charges in the photoelectric conversion region PD.

During a time period from timing T1 when the boosting transistor BX2 is set to the off state to timing T5, the boosting signal BS2 provided to the gate of the boosting transistor BX2 may have the first voltage VBB1. The first voltage VBB1 may be a negative voltage.

In the case of the dark state, when the transfer signal TS2 provided to the gate of the transfer transistor TX2 has the on-state voltage PCP (during a time period from T3 to T4), the floating diffusion region voltage FD_DARK of the dark state may increase.

In the case of the ideal image sensing device, the floating diffusion region voltage FD_DARK of the dark state may change like the floating diffusion region voltage curve VI. After the floating diffusion region voltage FD_DARK of the dark state decreases to the pixel voltage VDD, an image pixel signal may be output at timing T6.

When the transfer transistor TX2 and the floating diffusion region FD2 are coupled due to the degradation of the insulating layer, the floating diffusion region voltage FD_DARK of the dark state may change like the floating diffusion region voltage curve VN. The change in the floating diffusion region voltage FD_DARK of the dark state may be delayed due to the influence of the degradation of the insulating layer; in this case, even though timing T6 to output the image pixel signal arrives, the floating diffusion region voltage FD_DARK of the dark state may be higher than the pixel voltage VDD.

In the case of the unit pixel including the boosting transistor BX2, the floating diffusion region voltage FD_DARK of the dark state may change like the floating diffusion region voltage curve VB. As the negative voltage is applied to the gate of the boosting transistor BX2, in the time period from T5 to T6, the floating diffusion region voltage FD_DARK of the dark state may quickly decrease like the floating diffusion region voltage curve VB.

Below, the change in the floating diffusion region voltage FD_WHITE of the light receiving state will be described with reference to drawings.

When the transfer signal TS2 provided to the gate of the transfer transistor TX2 has the on-state voltage PCP (during the time period from T3 to T4), the floating diffusion region voltage FD_WHITE of the light receiving state may temporarily increase and may then decrease.

In the case of the ideal image sensing device, the floating diffusion region voltage FD_WHITE of the light receiving state may change like the floating diffusion region voltage curve VI. When the photo charges generated in the photoelectric conversion region PD2 are accumulated in the floating diffusion region FD2, the floating diffusion region voltage FD_WHITE of the light receiving state may decrease to the accumulation voltage VSV. In the case of the light receiving state, at timing T6, the ideal floating diffusion region voltage FD_WHITE may be the accumulation voltage VSV.

When the transfer transistor TX2 and the floating diffusion region FD2 are coupled due to the degradation of the insulating layer, the floating diffusion region voltage FD_WHITE of the light receiving state may change like the floating diffusion region voltage curve VN. The change in the floating diffusion region voltage FD_DARK of the dark state due to the coupling phenomenon may be delayed due to the influence of the degradation of the insulating layer, and a signal corresponding to photo charges, the amount of which is smaller than the amount of photo charges generated in the photoelectric conversion region PD2, may be output as the image pixel signal.

In the case of the unit pixel including the boosting transistor BX2, the floating diffusion region voltage FD_WHITE of the light receiving state may change like the floating diffusion region voltage curve VB. After the transfer signal TS2 provided to the gate of the transfer transistor TX2 transitions from the on-state voltage PCP to the off-state voltage NCP (at timing T4), at timing T5, the boosting signal BS2 provided to the gate of the boosting transistor BX2 may transition from the first voltage VBB1 to the second voltage VBB2 being lower than the first voltage VBB1. As the negative voltage is applied to the gate of the boosting transistor BX2, in the time period from T4 to T5, the floating diffusion region voltage FD_DARK of the light receiving state may quickly decrease like the floating diffusion region voltage curve VB.

According to various embodiments, a voltage transition delay of a floating diffusion region can be prevented by a boosting transistor connected to the floating diffusion region.

In some implementations, the boosting transistor may move photo charges transferred to the floating diffusion region to a pixel voltage terminal configured to supply power to a pixel.

Hereinabove, although the present disclosure has been described with reference to exemplary embodiments and the accompanying drawings, the present disclosure is not limited thereto. Various modification or enhancements to the disclosed embodiments and other embodiments can be devised based on what is described and/or illustrated in this patent document.

What is claimed is:

1. An image sensing device, comprising:
a photoelectric conversion region;
a floating diffusion region;
a transfer transistor connected to the photoelectric conversion region and the floating diffusion region and configured to turn on to operate in an on state to transfer photocharges in the photoelectric conversion region to the floating diffusion region; and
a boosting transistor connected to the floating diffusion region and configured to receive a negative voltage, after the transfer transistor transitions from an on state to an off state.

2. The image sensing device of claim 1, further comprising:
a reset transistor connected in series with the boosting transistor and configured to be turned on to reset the floating diffusion region.

3. The image sensing device of claim 1, further comprising:
a reset transistor connected in parallel with the boosting transistor and configured to be turned on to reset the floating diffusion region.

4. The image sensing device of claim 2, wherein a voltage of a boosting signal provided to the boosting transistor transitions from a positive voltage to the negative voltage, after a voltage of a transfer signal provided to the transfer transistor transitions from the on state to the off state.

5. The image sensing device of claim 3, wherein a voltage of a boosting signal provided to the boosting transistor transitions from the negative voltage to a lower negative voltage, after a voltage of a transfer signal provided to the transfer transistor transitions from the on state to the off state.

6. The image sensing device of claim 2, wherein the reset transistor connects the boosting transistor and a pixel voltage terminal configured to provide power to a pixel.

7. The image sensing device of claim 3, wherein the reset transistor connects the floating diffusion region and a pixel voltage terminal configured to provide power to a pixel.

8. The image sensing device of claim 3, wherein a voltage of a boosting signal provided to the boosting transistor decreases in response to a transition of a voltage of a reset signal provided to the reset transistor from the on state to the off state.

9. The image sensing device of claim 8, wherein the voltage of the boosting signal transitions from a positive voltage to the negative voltage, in response to the transition of the voltage of the reset signal from the on state to the off state.

10. The image sensing device of claim 2, wherein a voltage of a boosting signal transitions from the negative voltage to a positive voltage, before a voltage of a reset signal provided to the reset transistor transitions from an off state to an on state.

11. The image sensing device of claim 3, wherein a voltage of a boosting signal provided to the boosting transistor transitions from the negative voltage to a positive voltage, in response to a transition of a voltage of a reset signal provided to the reset transistor from the off state to the on state.

12. An image sensing device comprising:
a photoelectric conversion region configured to convert an incident light into photocharges;
a transfer transistor including a first end connected to the photoelectric conversion region;
a floating diffusion region connected to a second end of the transfer transistor, and configured to store the photocharges transferred from the photoelectric conversion region; and
a boosting transistor connected to the floating diffusion region.

13. The image sensing device of claim 12, wherein a voltage of a boosting signal provided to the boosting transistor decreases to a negative voltage, after a voltage of a transfer signal provided to the transfer transistor transitions from an on state to an off state.

14. The image sensing device of claim 13, further comprising:
a reset transistor including a first end connected to a pixel voltage terminal configured to supply power to a pixel,
wherein a second end of the reset transistor is in contact with the boosting transistor.

15. The image sensing device of claim 13, further comprising:
a reset transistor including a first end connected to a pixel voltage terminal,
wherein a second end of the reset transistor is in contact with the floating diffusion region.

16. The image sensing device of claim 14, wherein the voltage of the boosting signal transitions from a positive voltage to a negative voltage, after the voltage of the transfer signal transitions from the on state to the off state.

17. The image sensing device of claim 15, wherein the voltage of the boosting signal transitions from a negative voltage to a lower negative voltage, after the voltage of the transfer signal transitions from the on state to the off state.

18. The image sensing device of claim 16, wherein the voltage of the boosting signal transitions from a negative voltage to a positive voltage, before a voltage of a reset signal provided to the reset transistor transitions from an off state to an on state.

19. The image sensing device of claim 17, wherein the voltage of the boosting signal transitions from a negative voltage to a positive voltage, when a voltage of a reset signal provided to the reset transistor transitions from an off state to an on state.
